(19) United States
(12) Patent Application Publication
(10) Pub. No.: US 2011/0176493 A1
(43) Pub. Date: Jul. 21, 2011

(54) Method and Apparatuses for Processing a Message Comprising a Parameter for More Than One Connection

(76) Inventors: Kai Kiiskilä, Helsinki (FI); Katharina Kutyniok, Essen (DE)

(21) Appl. No.: 13/121,301

(22) PCT Filed: Sep. 29, 2008
(86) PCT No.: PCT/EP2008/063034

§ 371 Date: Mar. 28, 2011

(51) Int. Cl. H04W 40/00

(52) U.S. Cl. 370/328

(57) ABSTRACT

A method and a device for data processing are provided, wherein an IPCS message is processed including at least one parameter for more than one connection. Furthermore, a communication system is suggested including the device.

The invention relates to a method and to a device for data processing and to a communication system comprising such a device.

ITU-T Q.2631.1 defines a protocol to support dynamic establishment, modification and release of individual IP connections. The ITU-U Q.2631.1 protocol is reused in LTE to setup and to maintain GTP-U routes on top of IP. An application layer S1AP protocol provides means to setup several SAE bearers within one message. Each SAE bearer implicates the setup of one GTP-U route. An existing IPCS protocol can only setup one connection/GTP-U route per message. Thus each SAE bearer setup would have to be translated into several IPCS messages.

According to IPCS either a particular connection or all connections can be reset. If, e.g., one eNBs peer (S-GW) in an eUTRAN fails, each connection that was associated with this peer will have to be reset with a single IPCS reset message.

The current IPCS approach results in an increased amount of signaling load and thus a decreased performance as one SAE bearer setup may produce up to 256 internal IPCS ERQ messages, wherein 256 is the maximum number of bearers which can be setup with one SAE bearer setup request.

With an existing IPCS implementation only two kinds of reset are supported: A reset of a particular connection or a reset of all connections. Thus resetting of all connections for a particular IP address would result in many single IPCS reset messages thereby adding further messages to a failure scenarios and leading to an extended period of time for a recovery process.

The problem to be solved is to overcome the disadvantages stated above and in particular to provide an efficient approach of IPCS message handling thereby reducing an overall amount of signaling information and thus allowing a faster reaction of, e.g., a base station, on user requests.

This problem is solved according to the features of the independent claims. Further embodiments result from the depending claims.

In order to overcome this problem, a method for data processing is provided, wherein an IPCS message is processed comprising at least one parameter for more than one connection.

Hence, this at least on parameter may be used and/or applicable for more than one connection, in particular for more than one IP connection.

The approach in particular relates to an LTE system. For example, this approach further relates to a signaling of user plane connections (GTP-U routes), base station (e.g., eNB) internal signaling and signaling based on a protocol according to ITU-T Q.2631.1.

This solution allows to efficiently extend IP connection signaling (IPCS) in order to reduce an overall amount of signaling traffic, in particular within a communication device, e.g., a base station.

In an embodiment, said parameter comprises at least one of the following:
an identifier;
an IP information, in particular an IP address;
information relating to a particular connection;
a bandwidth information.

In another embodiment, processing said IPCS message comprises at least one of the following:
compiling the IPCS message;
transmitting the IPCS message;
receiving the IPCS message;
decompiling the IPCS message.

Such processing may be performed at a origin or sender of the IPCS message or at a receiver of the IPCS message or both.

In a further embodiment, the IPCS message comprises a reset message for all connections associated with an IP address.

Hence, all connections for a particular IP address can be reset with a single IPCS message.

In a next embodiment, the IPCS message comprises an IPCS meta-parameter.

It is also an embodiment that said IPCS meta-parameter is at least one of the following:
a connection establish list;
a successful establish list;
an unsuccessful establish list;
a connection release list;
a release confirm list;
a connection reset list;
a reset confirm list;
a connection modification list;
a successful modification list;
an unsuccessful modification list.

Pursuant to another embodiment, the meta-parameter is succeeded by mandatory and/or optional parameters for each connection.

According to an embodiment, the meta-parameter comprises
a list ID;
a field indicating a number of connections;
a length field.

According to another embodiment, the IPCS message comprises an IPCS request message or an IPCS response message.

In yet another embodiment, the IPCS response message comprises at least one of the following:
a list of at least one successfully modified, released, reset and/or setup connection and/or
a list of at least one unsuccessfully modified, released, reset and/or setup connection.

According to a next embodiment, the list of the at least one unsuccessfully modified, released, reset and/or setup connection comprises a reason of failure for each connection.

The at least one unsuccessfully modified, released, reset and/or setup connection may comprise a reason of failure for all connections.

Pursuant to yet an embodiment, the IPCS message comprises a handover message for a set of connections or for all connections from one base station to another.

The problem stated above is also solved by a device comprising a and/or being associated with a processor unit and/or a hard-wired circuit and/or a logic device that is arranged such that the method as described herein is executable on said processor unit.

According to an embodiment, the device is a communication device, in particular a or being associated with a base station (Node B (NB) or eNB) or with a terminal, especially with a mobile terminal (user terminal or user equipment).

The problem stated supra is further solved by a communication system comprising the device as described herein.

Embodiments of the invention are shown and illustrated in the following figures:

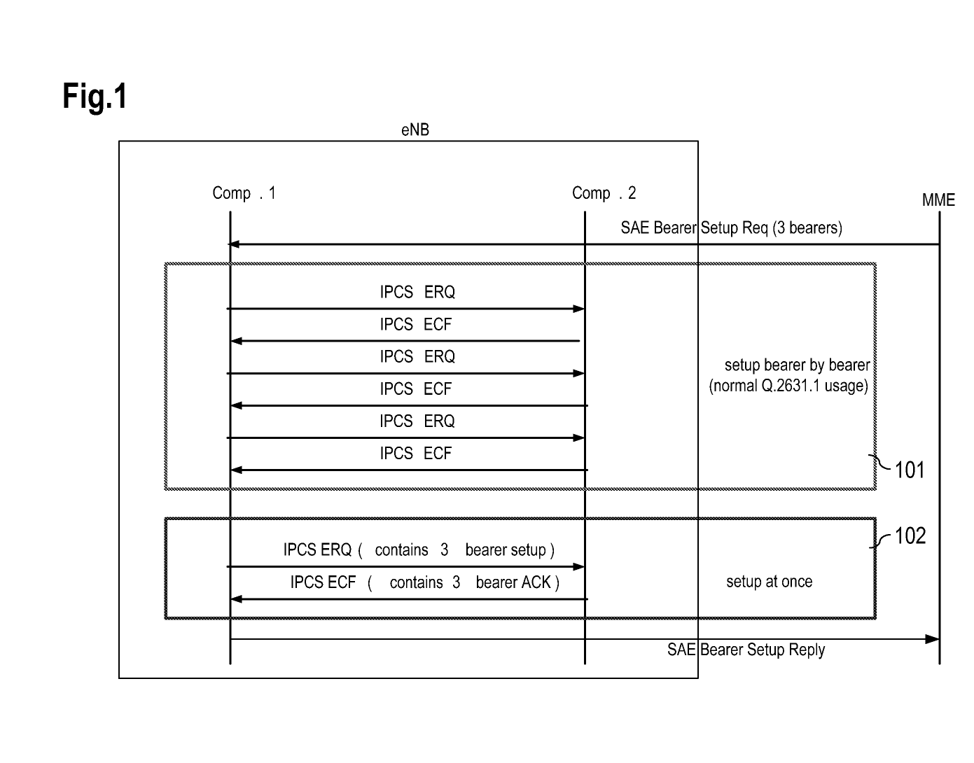

FIG. 1 shows a sequence approach versus parallel approach for setting up multiple bearers;

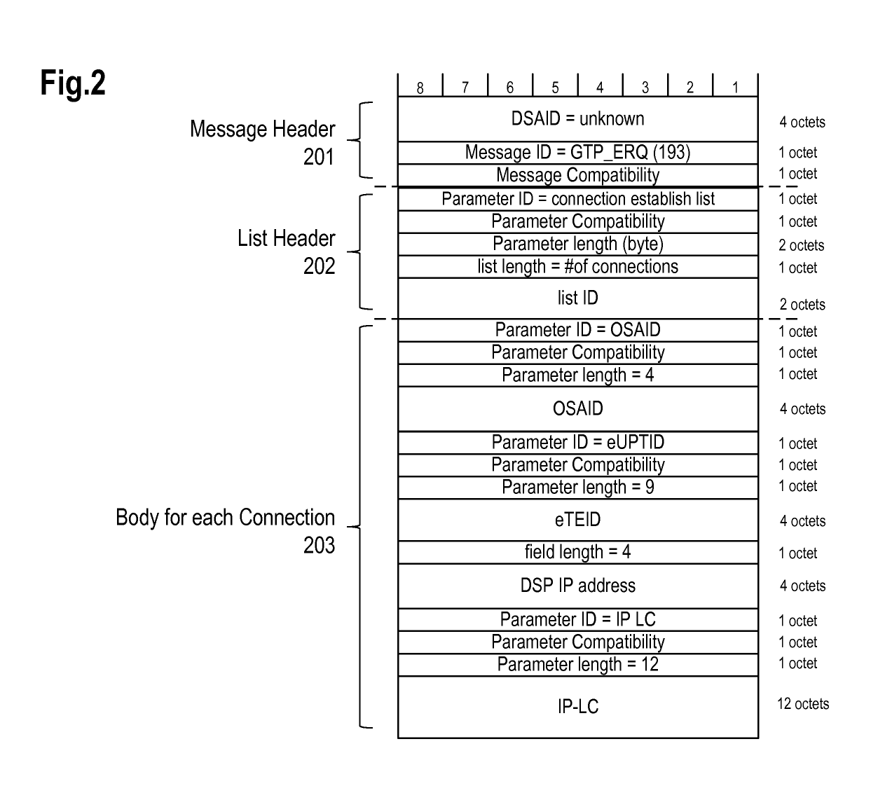

FIG. 2 shows an IPCS ERQ message used to setup a maximum of 40 connections/GTP-U routes;

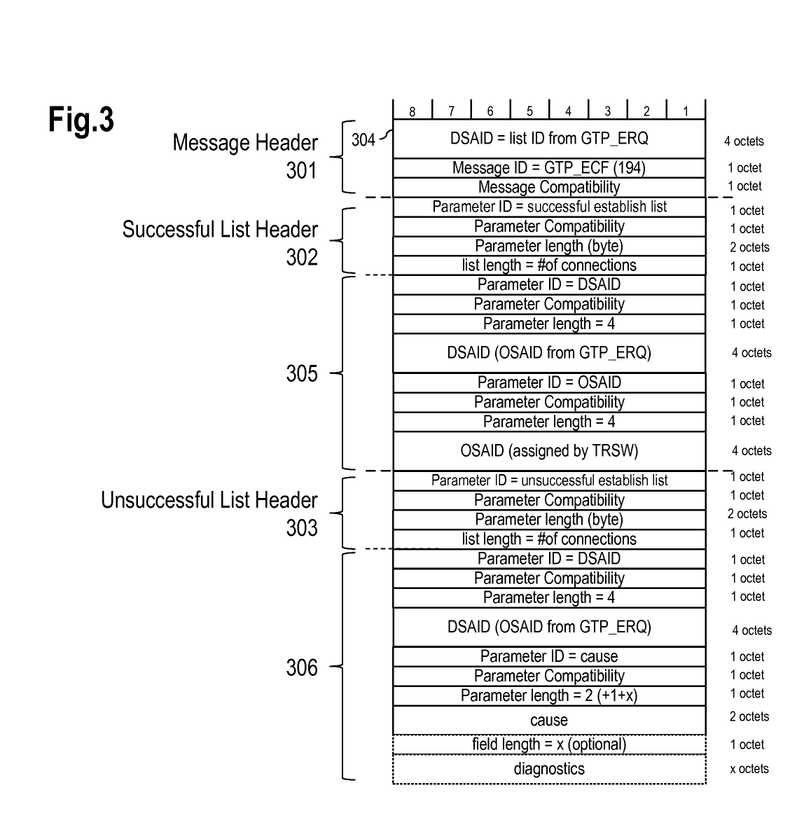

FIG. 3 shows an IPCS ECF message indicating a partly successful setup of the requested connections;

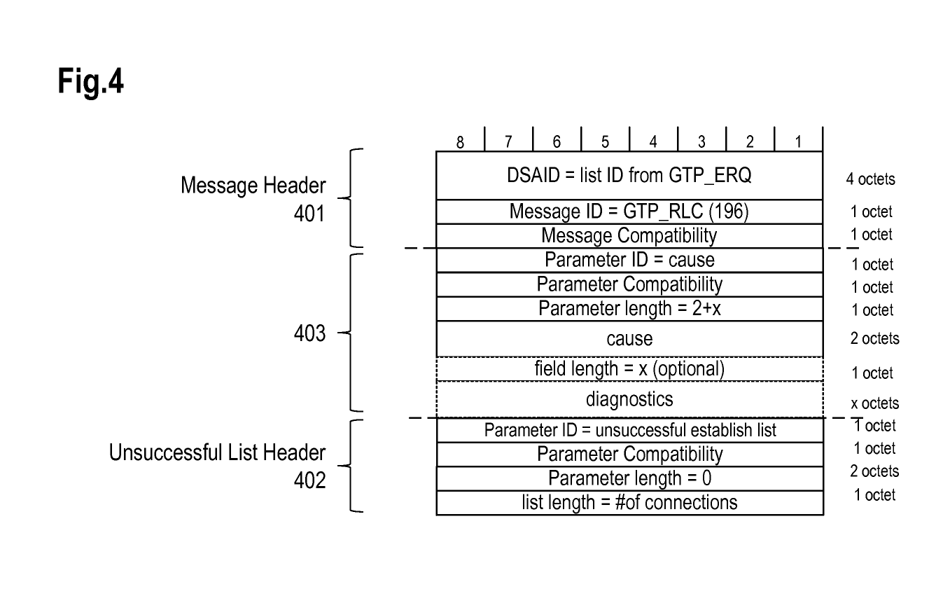

FIG. 4 shows an IPCS RLC message with all connections being rejected for the same reason;

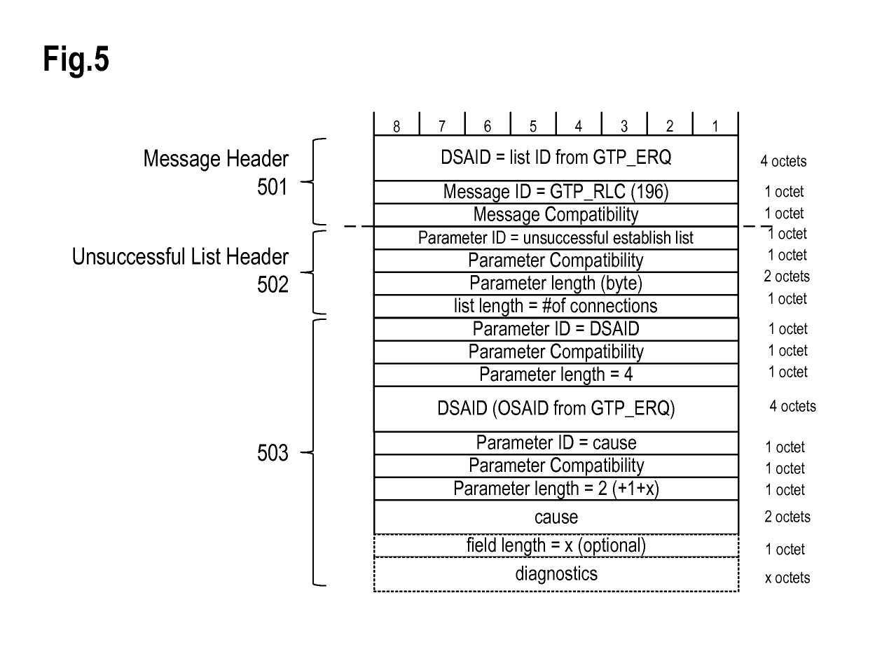

FIG. 5 shows an IPCS RLC message providing a cause of rejection for each particular connection along with its SAID;

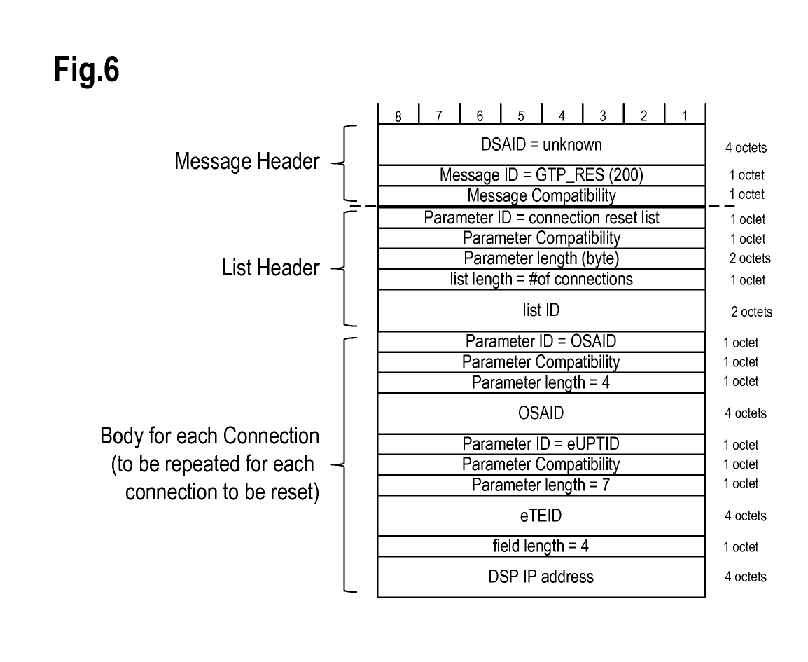

FIG. 6 shows a reset message with a multi-connection approach;

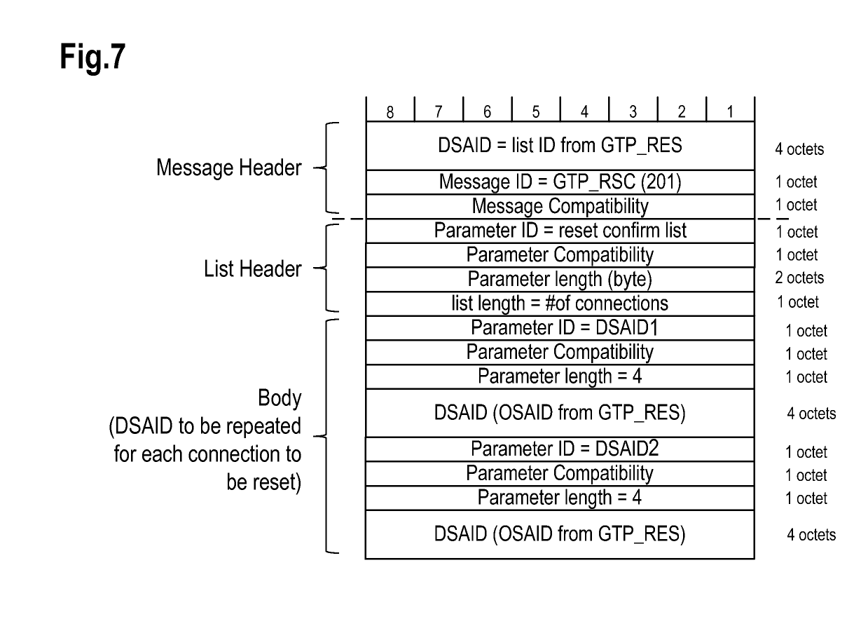

FIG. 7 shows a reset confirm message used to confirm the reset of several connections;

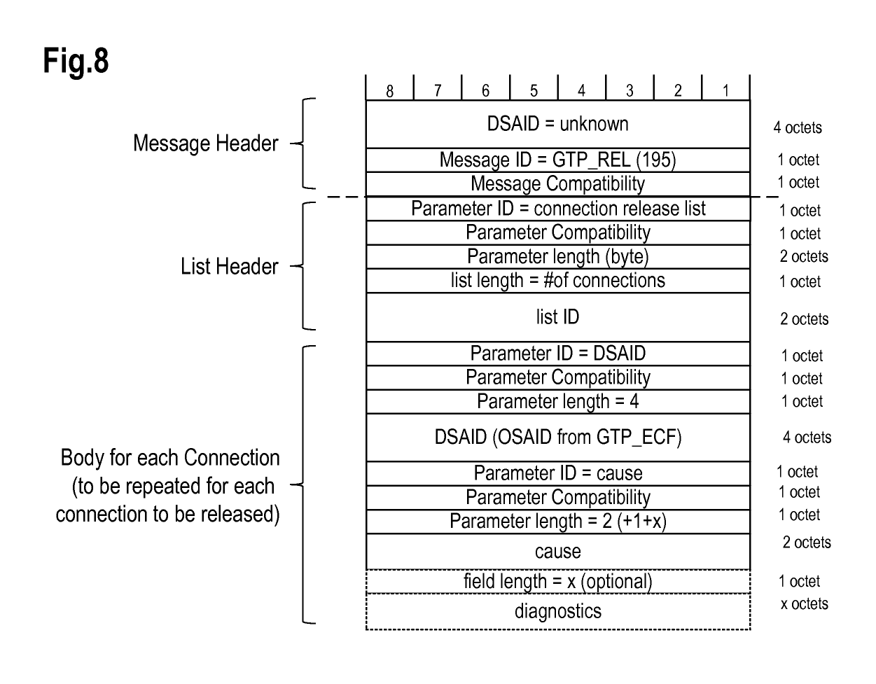

FIG. 8 shows an IPCS REL message, wherein for each released connection the reason for the release is conveyed;

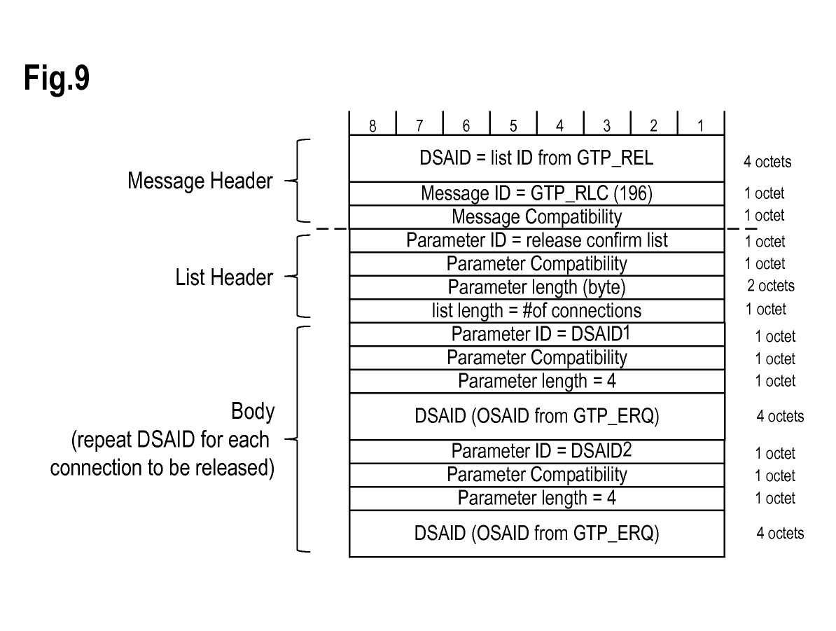

FIG. 9 shows multibearer IPCS RLC messages;

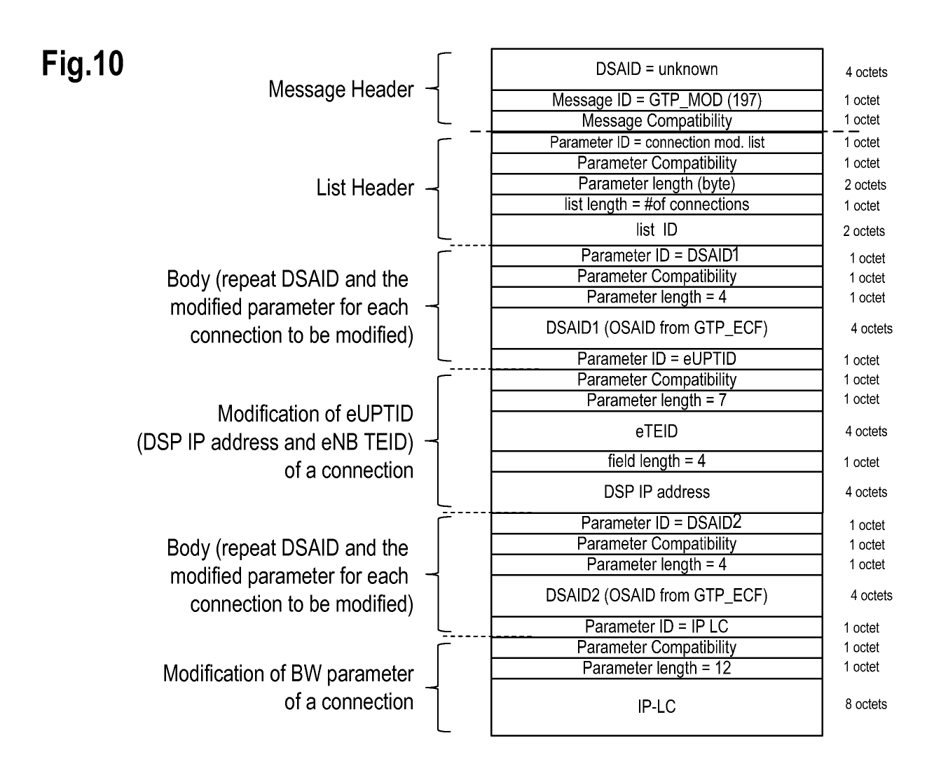

FIG. 10 shows a multibearer IPCS MOD message, wherein only one parameter of a connection can be modified at a time;

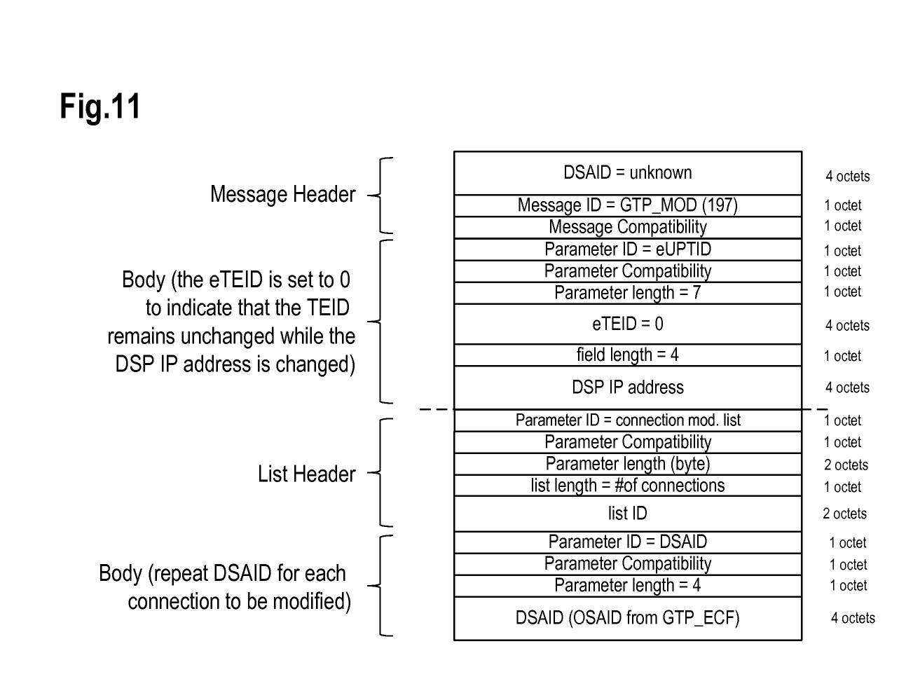

FIG. 11 shows an exemplary message as how to modify an IP address for multiple connections;

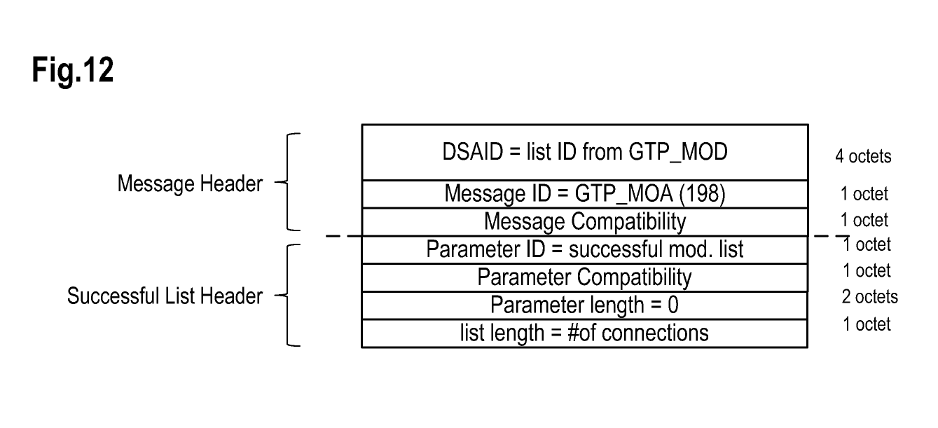

FIG. 12 shows an IPCS MOA message indicating that all connections could be modified as requested;

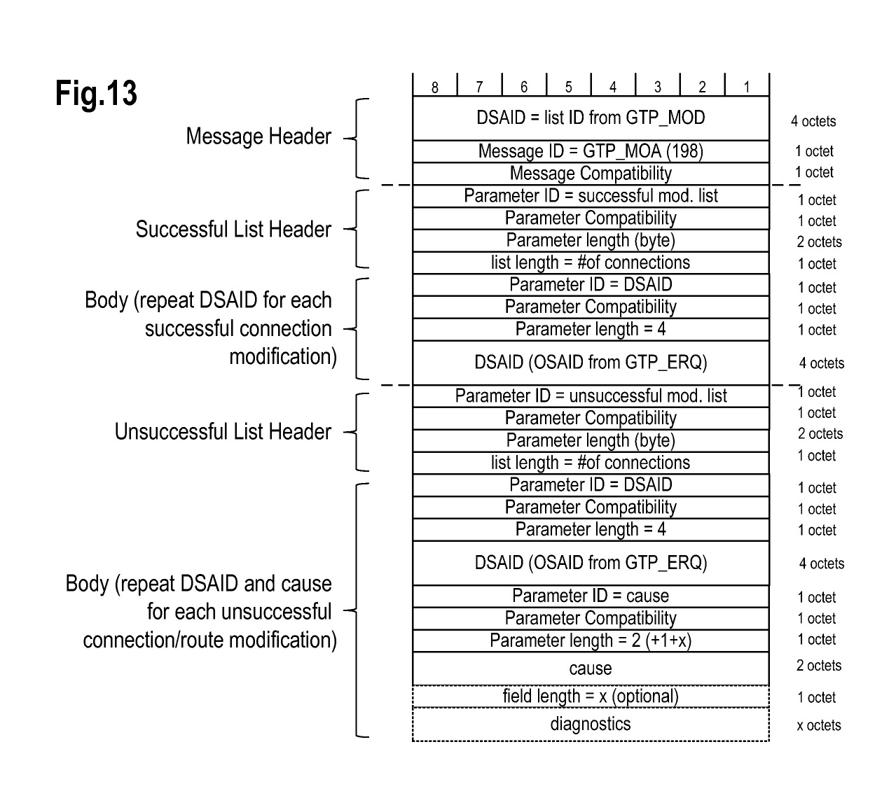

FIG. 13 shows an IPCS MOA message indicating successful and unsuccessful modifications;

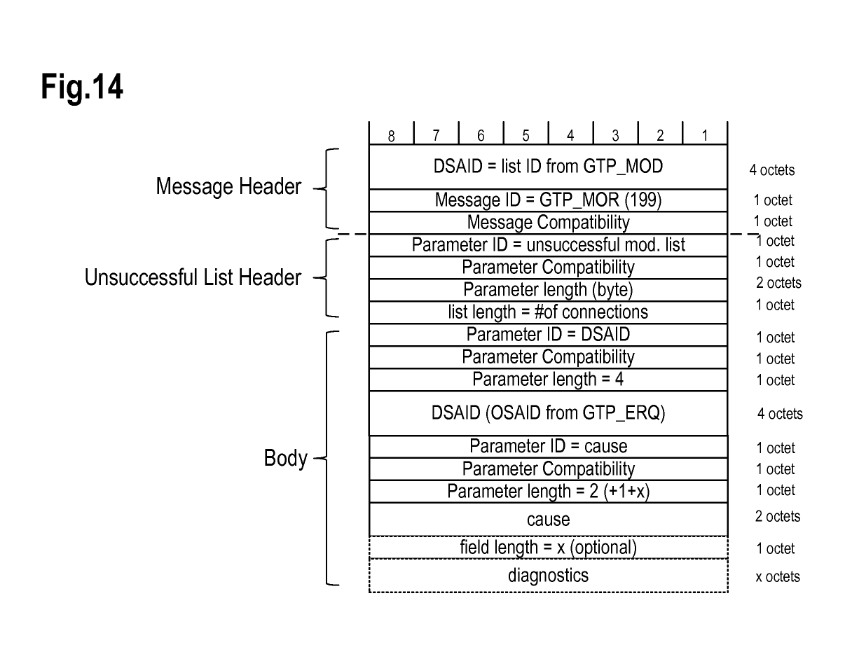

FIG. 14 shows an IPCS MOR message rejecting the modification of all connections, wherein for each connection a parameter indicating the reason of failure is provided.

The approach provided in particular introduces at least one IPCS meta-parameter for setting up a predefined number of connections that can be transported with a single IPCS message.

This efficiently reduces a processing load of signaling entities and allows a faster service for the end-user. The meta-parameter comprises information regarding a number of requested connections and may in particular be succeeded by mandatory and/or optional parameters for each connection.

FIG. 1 shows a sequence approach versus parallel approach for setting up multiple bearers and/or connections utilizing an IPCS protocol. A signaling instance such as a multimedia mobile equipment (MME) sends an “SAE Bearer Setup Request” for 3 bearers to a base station eNB. A box 101 visualizes as how setting up bearers is processed on a single bearer basis according to ITU-T Q.2631.1, whereas a box 102 shows as how such setting up of several bearers can be achieved by a single IPCS message comprising several parameters. According to FIG. 1, the base station eNB comprises different layers depicted as “Comp.2” and “Comp.1” exchanging IPCS messages as a result to the “SAE Bearer Setup Request” received by the MME.

The meta-parameter's ID “list ID” preferably ensures a proper mapping of a request and a confirm and/or a reject at the sender's site. The response may inform about a successful or an unsuccessful establishment, release and/or modification information. In case of an unsuccessful event of information, a reason for the rejection of the establishment and/or modification can be provided for each single connection.

A preferable use case relates to an establishment and/or a release of all connection for one user (which currently allows up to eight connections in LTE) with a single IPCS message. Also, a handover of all connections from one cell to another within the same eNB can be facilitated by a single IPCS modification request and the corresponding modification acknowledge and/or reject message.

Additionally, a reset of all connection for a particular IP address is introduced by this approach.

Advantageously, a common IPCS message format is extended by a new meta-parameter, e.g., a list header. The list header may comprise
a list ID, which will be reused in the response to a map request and response;
a field indicating the number of connections; and
a length field.

The length field could either comprise only the parameter's own length or it may introduce a hierarchy and contain also the subsequent parameters' length information.

Subsequent to the list header, mandatory as well as optional parameters for the particular connection are provided. There may be a fixed order of parameters for a connection and/or the parameters for a particular connection can be provided one after another.

For example, up to 40 connections may be established within one IPCS message utilizing a 2 byte “parameter length” field.

Advantageously, the total number of connections may not exceed 8 in LTE.

FIG. 2 shows an IPCS ERQ message used to setup a maximum of 40 connections/GTP-U routes. A Message Header 201 is followed by a List Header 202 and further a body 203. The body 203 is repeated for each route to be set up. The actual number of connections [1 . . . 40] to be set up is indicated in the list length field of the List Header 202.

FIG. 3 shows an IPCS ECF message indicating a partly successful setup of the requested connections. Such IPCS ECF messages comprises a Message Header 301, a Successful List Header 302 and an Unsuccessful List Header 303. The IPCS ECF message can be used to indicate a successful setup of connections as well as a reason for an unsuccessful setup.

A field 304 is set to a sequence ID received in GTP_ERQ, in particular 2 upper octets can be set to 0 in case the list ID comprises 2 octets only.

A portion 305 can be repeated for each route that is successfully set up. A number of connections can be indicated in the list length field of Header 302.

A portion 306 can be repeated for each route not successfully set up. A number of connections can be indicated in the list length field of Header 303. There may be at least one successfully established connection, otherwise an RLC message may be sent.

For all successfully established connections an originating party is informed of the IDs of the connections assigned by the peer (OSAID) together with the ID received (DSAID).

The originating party thus can map its own ID to the peer's ID for each connection. In case of a failed connection, the reason of failure can be provided along with the received ID (DSAID in ECF=OSAID received in ERQ), informing the peer (originating party) about the reason for the failure for each connection.

FIG. 4 shows an IPCS RLC message with all connections being rejected for the same reason.

The IPCS RLC message comprises a Message Header 401, a body 403 and an Unsuccessful List Header 402.

The Header 402 may be only used to indicate that the failed establish request was for a list of connections. The parameter length can be set to 0 as no particular information is to be conveyed. However, the number of connections can be provided in the list length field.

The body 403 may be optional.

The DSAIDs received in GTP_ERQ could be added to the message if it turns out that this is needed for proper connection handling and/or cleanup at the peer.

In such case, it is not required providing all SAIDs received with a reason of failure for each of them.

FIG. 5 shows an IPCS RLC message providing a cause of rejection for each particular connection along with its SAID.

Such IPCS RLC message comprises a Message Header 501, an Unsuccessful List Header 502 and a portion 503 that repeats the DSAID and a reason of failure for each connection that has not been successfully set up (all connections in this special case).

The IPCS RLC message according to FIG. 4 saves a reasonable amount of bytes in the IPCS RLC message. The amount of saved bytes can be in the order of 67 bytes for a rejection of 8 connections.

Preferably, the DSAID can be utilized as a parameter that is also present in the message's payload. As the DSAID parameter length and the list length are provided in the list header, the DSAID could be used as is (without any parameter header). However, as an alternative, a DSAID ID can be introduced updating the DSAID to a standalone IPCS parameter.

FIG. 2 to FIG. 5 present three embodiments of list IDs. The approach presented in particular provides ten lists that can be summarized as follows:

| IPCS meta-parameter | Size | Identifier |
|---|---|---|
| connection establish list | 3 bytes | 1 1 0 0 0 0 0 0 |
| successful establish list | 1 byte | 1 1 0 0 0 0 0 1 |
| unsuccessful establish | 1 byte | 1 1 0 0 0 0 1 0 |
| connection release list | 3 bytes | 1 1 0 0 0 0 1 1 |
| release confirm list | 1 byte | 1 1 0 0 0 1 0 0 |
| connection reset list | 3 bytes | 1 1 0 0 0 1 1 0 |
| reset confirm list (RSCL) | 1 byte | 1 1 0 0 0 1 1 1 |
| connection modification | 3 bytes | 1 1 0 0 1 0 0 1 |
| successful modification | 1 byte | 1 1 0 0 1 0 1 0 |
| unsuccessful modification | 1 byte | 1 1 0 0 1 0 1 1 |

According to the IPCS ERQ message, the release, the modification and the reset events may handle several connections with a single IPCS message. Such scenarios are shown in FIG. 6 to FIG. 14. Preferably, the IPCS meta-parameters as stated before are utilized.

FIG. 6 shows a reset message with a multi-connection approach. If the list header is omitted (and the message ID is changed) the standard IPCS message remains. By setting the TEID field to 0, all connections for the IP address are reset.

FIG. 7 shows a reset confirm message used to confirm the reset of several connections. For each reset connection, a DSAID received in the reset message is provided.

FIG. 8 shows an IPCS REL message. For each released connection the reason for the release is conveyed.

FIG. 9 shows multibearer IPCS RLC messages. DSAIDs of connections that could not be released (which are, e.g., unknown) are omitted in the release confirmation.

FIG. 10 shows a multibearer IPCS MOD message. Only one parameter of a connection can be modified at a time. The example of FIG. 10 shows two modifications: For connection 1 (with DSAID1) the eUPTID parameter is modified and for connection 2 (with DSAID2) the IP-LC parameter is modified.

FIG. 11 shows an exemplary message as how to modify an IP address for multiple connections. In contrast to the other messages, in this modification the eUPTID parameter is outside of the meta-parameter.

FIG. 12 shows an IPCS MOA message indicating that all connections could be modified as requested.

The “Successful List Header” of FIG. 12 may be only used to indicate that the successful modification request shall apply for a list of connections. A parameter length can be set to 0 as no particular information is passed. The number of connections can be provided with the list length field.

The DSAIDs received in GTP_ERQ could be added to the message if it turns out that this is needed for proper connection handing and/or cleanup at the peer.

FIG. 13 shows an IPCS MOA message indicating successful and unsuccessful modifications. The unsuccessful modification can be supplemented by a parameter indicating the reason for the failure regarding each connection.

It is noted that there may at least be one successful modification, otherwise a MOR message may be sent.

FIG. 14 shows an IPCS MOR message rejecting the modification of all connections. For each connection a parameter indicating the reason of failure is provided.

Further to supporting multi-connection handling within one message, an additional feature is introduced allowing to reset all connections for a particular IP address. This bears the advantage to reset all connections for a particular IP address without considering a UDP port. A corresponding parameter can be set to 0 to indicate that all connections for the IP address affected are to be reset.

In LTE an IPTA parameter is not used. Instead, a parameter UPTID (combination of TEID and IP address) is introduced. A suggestion to reset all connections for a particular IP address is to set the TEID value to 0 and only provide the affected IP address. Such concept can be easily reused in combination with current IPCS messaging. Advantageously, the approach provided enhances the IPCS protocol thereby reducing a signaling load and accelerating a clean-up of failure scenarios. FIG. 6 shows the combination of both improvements, i.e. multi-connection handling and reset of all connection for a particular IP address (TEID set to 0).

Hence, the approach provided allows to reduce the amount of messages required for setup, release, modification events thereby efficiently reducing an overall signaling load at the base station. Furthermore, the end-user experience is improved as for setup and/or handover events all S1 bearers required can be simultaneously set up. Also, all connections for a particular IP address may be reset at once, i.e. with a single message.

### LIST OF ABBREVIATIONS

DSAID destination signaling association identifier

ECF establish confirm

eNB evolved Node B

ERQ establish request

GTP-U GPRS Tunneling Protocol Userplane

IPCS IP connection signaling

IPTA IP transport sink address

LTE long term evolution

MOA modification acknowledge

MOD modification request

MOR modification reject

OSAID originating signaling association identifier

REL release request

RES reset request

RLC release confirm

RSC reset confirm

S1AP S1 Application Protocol

S-GW Serving Gateway

TEID tunneling endpoint identifier

UPTID user plane transport identifier

WMP world market product

1. A method for data processing, wherein an IPCS message is processed comprising at least one parameter for more than one connection.

2. The method according to claim 1, wherein said parameter comprises at least one of the following:
an identifier;
an IP information, in particular an IP address;
information relating to a particular connection;
a bandwidth information.

3. The method according to claim 1, wherein processing said IPCS message comprises at least one of the following:
compiling the IPCS message;
transmitting the IPCS message;
receiving the IPCS message;
decompiling the IPCS message.

4. The method according to claim 1, wherein the IPCS message comprises a reset message for all connections associated with an IP address.

5. The method according to claim 1, wherein the IPCS message comprises an IPCS meta-parameter.

6. The method according to claim 5, wherein said IPCS meta-parameter is at least one of the following:
a connection establish list;
a successful establish list;
an unsuccessful establish list;
a connection release list;
a release confirm list;
a connection reset list;
a reset confirm list;
a connection modification list;
a successful modification list;
an unsuccessful modification list.

7. The method according to claim 5, wherein the meta-parameter is succeeded by mandatory and/or optional parameters for each connection.

8. The method according to claim 5, wherein the meta-parameter comprises
a list ID;
a field indicating a number of connections;
a length field.

9. The method according to claim 1, wherein the IPCS message comprises an IPCS request message or an IPCS response message.

10. The method according to claim 9, wherein the IPCS response message comprises at least one of the following:
a list of at least one successfully modified, released, reset and/or setup connection and/or
a list of at least one unsuccessfully modified, released, reset and/or setup connection.

11. The method according to claim 10, wherein the list of the at least one unsuccessfully modified, released, reset and/or setup connection comprises a reason of failure for each connection.

12. The method according to claim 1, wherein the IPCS message comprises a handover message for a set of connections or for all connections from one base station to another.

13. A device comprising a and/or being associated with a processor unit and/or a hard-wired circuit and/or a logic device that is arranged such that the method according to claim 1 is executable thereon.

14. The device according to claim 13, wherein said device is a communication device, in particular a or being associated with a base station or a terminal.

15. Communication system comprising the device according to claim 13.
